(19) United States
(12) Patent Application Publication
(10) Pub. No.: US 2014/0257627 A1
(43) Pub. Date: Sep. 11, 2014

(54) POTENTIAL CHASSIS DAMAGE IDENTIFICATION AND NOTIFICATION SYSTEM

(71) Applicant: FORD GLOBAL TECHNOLOGIES, LLC, Dearborn, MI (US)

(72) Inventor: Daniel Lee Hagan, Jr., Oakland, MI (US)

(73) Assignee: FORD GLOBAL TECHNOLOGIES, LLC, Dearborn, MI (US)

(21) Appl. No.: 13/792,516

(22) Filed: Mar. 11, 2013

(51) Int. Cl. G01M 17/007

(52) U.S. Cl. CPC G01M 17/007
USPC 701/33.8

(57) ABSTRACT

A system for monitoring components within a vehicle to determine if chassis damage may have occurred. The system has a controller which receives data from at least one sensor connected to a component on the vehicle and compares the data to a threshold value or potential-damage range of values. If the data is above the threshold value, or within the potential-damage range, the controller sends a potential-chassis-damage notification signal. The signal may be sent to an instrument panel giving a service chassis indication, stored in an on-board storage device to be accessed later, or sent outside of the vehicle to a remote receiver.

### TECHNICAL FIELD

This disclosure relates to a system used to identify potential damage to a vehicle chassis and sending a notification signal if potential damage is detected.

### BACKGROUND

A chassis consists of an internal framework that supports a vehicle. A chassis typically consists of a frame, a suspension system, and ground-contact components such as wheels. A suspension system typically consists of springs, shock absorbers and linkages that connect the vehicle's ground-contact components to its frame. The chassis contributes to the vehicle's driving, steering and braking while keeping occupants comfortable and reasonably well isolated from noise, bumps, and vibrations. The suspension system maintains the ground-contact components in contact with the ground surface as much as possible to allow for safe driving, steering and braking of the vehicle.

Chassis systems are tuned to provide the best handling of the vehicle while minimizing noise, vibrations and harshness transferred to the frame and other vehicle components. Chassis systems are typically tuned so that an unsprung mass of the vehicle follows the changing contours of the ground while a sprung mass of the vehicle maintains a steady and smooth ride. Chassis systems of vehicles are also designed to be robust enough to traverse the ground contours that the vehicle is likely to encounter. Damage to the chassis may reduce vehicle handling, steerability, and brakeability. Durability testing may be conducted on chassis systems to ensure safety and robustness of the system. In automobiles, it is desirable that the chassis system either withstand no damage during the durability testing or if damage occurs that the damage be discernible or detectable by the driver. Detection of potential damage to the chassis is normally determined based on tire pressure loss, visible tire damage, wheel imbalance, visible wheel damage, ride quality changes, suspension noise, and steering system changes.

Drive-by-wire, steer-by-wire and brake-by-wire systems increase the difficulty for a driver to detect potential chassis damage. Drivers of vehicles that are shared by multiple drivers may not know about, or notice, potential chassis damage that occurred during a prior user's operation of the vehicle. Pool and rental vehicles may be inspected when the vehicle is turned in, but in a scenario where the hand-off of the vehicle occurs without a check-in inspection, the subsequent driver could be unaware that they are operating a vehicle with potential chassis damage.

The above problem(s) and other problems are addressed by this disclosure as summarized below.

### SUMMARY

According to one aspect of this disclosure, a potential chassis damage detection and notification system is provided for a vehicle. One or more sensors connected to the vehicle provide data relating to the operation of the vehicle. The data is received by a chassis damage controller which compares the data to a potential-damage range, and sends a potential-chassis-damage signal if the data is detected that is within the potential-damage range. The potential-damage range is set at values that are above those experienced during the normal operation of the vehicle and at the same time are below the values of data that would set off a supplemental restraint.

The potential chassis damage notification system may display an indication of potential chassis damage on an instrument panel. The potential chassis damage notification system may transmit a notification outside of the vehicle. The potential chassis damage notification system may save the information to be accessed at a later time.

According to another aspect of this disclosure, a method of identifying potential chassis damage on a vehicle is disclosed. The method includes receiving a signal containing acceleration data, comparing the acceleration data to a threshold value, and sending a potential-chassis-damage signal if the acceleration data is above the threshold value.

The above aspects of this disclosure and other aspects will be explained in greater detail below with reference to the attached drawings.

### BRIEF DESCRIPTION OF THE DRAWINGS

FIG. 1 is a diagrammatic view of a of a chassis damage controller system capable of receiving acceleration data and sending a notification signal if potential chassis damage has occurred.

### DETAILED DESCRIPTION

The illustrated embodiments are disclosed with reference to the drawings. However, it is to be understood that the disclosed embodiments are intended to be merely examples that may be embodied in various and alternative forms. The FIGURES are not necessarily to scale and some features may be exaggerated or minimized to show details of particular components. The specific structural and functional details disclosed are not to be interpreted as limiting, but as a representative basis for teaching one skilled in the art how to practice the disclosed concepts.

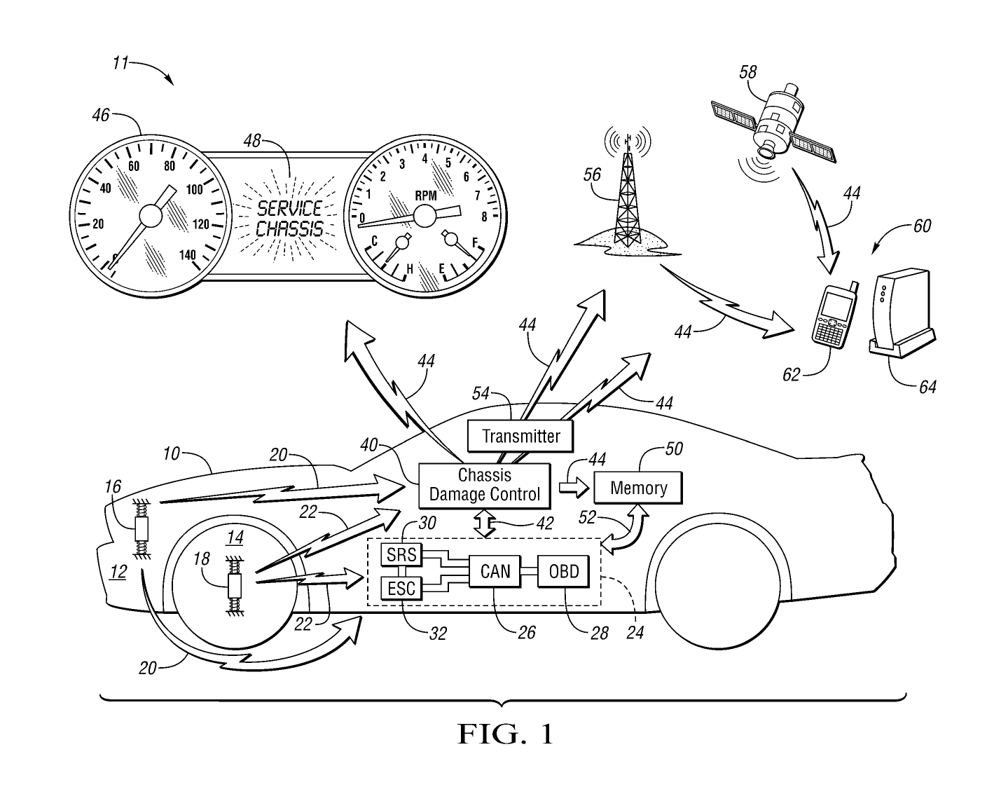

FIG. 1 shows a representation of a vehicle 10 having a potential chassis damage notification system 11. The vehicle 10 is bifurcated into its sprung mass 12 and unsprung mass 14. A sprung accelerometer 16 is shown connected to the sprung mass 12 and an unsprung accelerometer 18 is shown connected to the unsprung mass 14. Alternatively, a single accelerometer 16 or 18 may be connected to either the sprung or unsprung mass 12, 14, a set of accelerometers 16 or 18 may be connected to either the sprung or unsprung mass 12, 14, or any combination of the above may be used with the system 11.

The unsprung mass 14 bears the weight of the vehicle 10. The unsprung mass 14 is made up of, and may also be referred to as, unsprung components 14. Unsprung components 14 include suspension and ground contact components such as wheels, tires, tracks, skis, hub and bearing assemblies, knuckles, brakes, and portions of driveshafts, springs, shock absorbers, suspension links, and steering systems. The sprung mass 12 is the weight of the vehicle supported by the unsprung components 14. The sprung mass 12 of the vehicle 10 is made up of, and may also be referred to as, sprung components 12. The sprung mass 12 includes vehicle components such as the frame, a body, an engine, and also may include items in the interior compartment of the vehicle such as passengers and cargo.

Each accelerometer 16, 18 measures acceleration of the component 12, 14, structure, or system to which it is attached. When a component 12, 14 impacts an object, the component 12, 14 may change its position or direction. A change in position or direction may include an acceleration. The sprung accelerometer 16 may provide the acceleration experienced by a sprung component 12 in a sprung-mass-acceleration signal 20. The unsprung accelerometer 18 may provide the acceleration experienced by an unsprung component 14 in an unsprung-mass-acceleration signal 22.

The unsprung-mass-acceleration signal 22 provides data of the level of impact an unsprung component 14 has with an object. The sprung-mass-acceleration signal 20 may also provide data of the level of impact an unsprung component 14 has with an object. The acceleration of the sprung component 12 is damped by the unsprung mass 14 within the travel limits of the suspension of vehicle 10. The suspension of vehicle 10 has ‘bottomed out’ when the suspension comes into contact with the frame. In a situation where the suspension system has ‘bottomed out,’ the sprung-mass and unsprung-mass-acceleration signals 20, 22 may be the same.

The sprung-mass-acceleration signal 20 may indicate the jolt felt by a driver within the vehicle 10. The differential between accelerations may indicate the suspension travel relative to the frame and whether or not the suspension ‘bottomed out.’ A differential between the sprung-mass and unsprung-mass-acceleration signals 20, 22 may also indicate an impact of an unsprung component 14 with an object without the driver being aware of the impact or potential resulting damage.

Alternatively other sensors may be used in place of accelerometers 16, 18. Sensors used to detect position, velocity, acceleration, jerk, vibration or strain of components 12, 14 may be used with the potential chassis damage notification system 11. The sensors that may be used are of the kind capable of providing data to the potential chassis damage notification system 11 which may be analyzed to indicate that a unsprung component 14 has impacted an object and to a level which may have caused damage to the chassis of the vehicle 10. Examples of alternative sensors include position sensors, velocity sensors, jerk sensors, vibration sensors, shock-wave sensors, impact sensors, tactile sensors, strain gauges, pressure transducers, and piezoelectric transducers.

Vehicle 10 is shown with an internal communications network 24 that interconnects electronic systems within the vehicle. The network 24 may have certain protocols that are followed such as a Controller Area Network (CAN) 26 or a Local Interconnect Network (LIN). Special requirements for vehicle control may be included in the network 24 such as assurance of message delivery, assured non-conflicting messages, assured time of delivery, EMF noise resilience, and illumination of redundant routing. Additional demands on the network 24 must be minimalized to reduce costs.

Vehicle 10 is shown with an On-Board Diagnostics (OBD) connector 28 that has access to the network 24. Vehicle 10 is also shown with a Supplemental Restraint System (SRS) 30 and an Electronic Stability Control (ESC) system 32. The supplemental restraint system 30 may use accelerometers 16, 18 to aid in the detection of a collision event. The electronic stability control system 32 may also use accelerometers 16, 18, in combination with other sensors, to improve the safety of a vehicle's stability. Accelerometers 16, 18, may provide data 20, 22 to the internal communications network 24 and the data 20, 22 may be shared by the potential chassis damage notification system 11 as well as other vehicle systems.

A potential-chassis-damage controller 40 is provided within the vehicle 10. The controller 40 may be in communication with the network 24, as represented by arrow 42. The controller 40 may access data 20, 22 through the internal communications network 24. However, a network 24 is not required for the system 11 to function. The accelerometers 16, 18 may be independent from other systems and the controller 40 may directly receive the signals 20, 22 from one or both accelerometers 16, 18.

The controller 40 compares the acceleration data 20, 22 of at least one accelerometer 16, 18 to a pre-set threshold value or range of values that indicate potential damage to the chassis of vehicle 10. The threshold value or potential-damage range may be unique for each kind of accelerometer 16, 18 and for each individual accelerometer 16, 18 depending on which sprung or unsprung component 12, 14 they are attached to. The controller 40 may also compare a differential between a sprung-mass acceleration signal 20 and an unsprung-mass acceleration signal 22. The controller 40 sends out a potential-chassis-damage signal 44 if the acceleration data 20, 22 is within the potential-damage range or above the threshold value.

The potential-damage range has a lower limit set higher than acceleration experienced by the accelerometers 16, 18 during normal vehicle use to avoid unnecessary notifications. The potential-damage range has an upper limit set lower than the value of acceleration data 20, 22 that would indicate a collision event sufficient to set off a supplemental restraint. There is no need to set the level above the level sufficient to trigger a supplemental restraint response because the vehicle will be ordinarily serviced after such a collision event. This will also reduce computational redundancy and allow the supplemental restraint system 30 to operate without competition from the potential chassis damage notification system 11 or provide additional demands on the network 24. A portion of the potential-damage range may be advantageously set at an acceleration value measured during an event that may cause chassis damage yet may not be discernible or detectable by the driver. For example, the potential-damage range may include an acceleration that the sprung accelerometer 18 experiences when the vehicle 10 drives straight-on over a 7 inch straight-edge curb at 15 miles per hour, even if chassis damage is not discernible or detectable by the driver.

The controller 40 may send a potential-chassis-damage signal 44 to an instrument panel 46. The instrument panel 46 may have a digital display or light 48 which notifies the driver of potential chassis damage. The instrument panel 46 may provide a ‘service chassis’ indication that is communicated to the driver through the digital display or by illuminating the light 48 in response to receiving the potential-chassis-damage signal 44.

The controller 40 may send the potential-chassis-damage signal 44 to a memory storage device 50. The potential-chassis-damage signal 44 may include the original acceleration data 20, 22 that is above the threshold value or within the potential-damage range. The potential-chassis-damage signal 44 may be saved in the memory storage device 50 with a time stamp to be accessed at a later time. The potential-chassis-damage signal 44 may also be saved in the memory storage device 50 with GPS data, or the like, providing location information of the vehicle 10 at the time of the event. The potential-chassis-damage signal 44, or the data 20, 22 that is within the potential-damage range, may be recalled from the memory storage device 50 directly through a separate communication tool (not shown). The memory storage device 50 may also be in communication with the network 24, as indicated by arrows 52. The potential-chassis-damage signal 44, or data 20, 22 that is within the potential-damage range, may be accessed through the OBD connector 28.

The vehicle 10 may be equipped with a transceiver or transmitter 54 and the controller 40 may be in communication with the transmitter 54 and capable of sending the potential-chassis-damage signal 44 outside of the vehicle 10 through the transmitter 54. The transmitter 54 may be configured to send the potential-chassis-damage signal 44 via methods such as a cellular network or radio frequency broadcast, as represented by tower 56, or a satellite network as represented by satellite 58.

A receiver 60 located outside of the vehicle 10 may be in communication with the tower 56 or satellite 58. The remote receiver 60 may be inside a portable electronic device 62, such as a cellular phone, satellite phone or tablet. The remote receiver 60 may also be connected to and accessible via the internet, as represented by server 64. The remote receiver 60 receives the potential-chassis-damage signal 44 and may actively notify a user outside of the vehicle 10. The remote receiver 60 may also merely provide access to information pertaining to the potential chassis damage of the vehicle 10.

Alternatively, the potential-chassis-damage signal 44, or the acceleration data 20, 22 above the threshold value or within the potential-damage range, may be directly transmitted to a receiver 60 without the use of a radio frequency, cellular or satellite network 56, 58. Examples of other forms of wireless transmission that may also be used include infrared, ultrasonic, direct transmission of a radio frequency without use of a network, citizen band and Bluetooth transmissions.

The potential chassis damage notification system 11 notifies drivers of vehicles of potential chassis damage. This may be useful when there is potential damage to the chassis which is neither discernible nor detectable by a driver. This may also be useful for drivers of vehicles that are shared by multiple drivers. A driver may be notified by the system 11 of potential chassis damage that occurred when a prior user operated the vehicle. Pool and rental vehicles may be transferred between drivers without concern that a subsequent driver would be operating the vehicle with potential chassis damage. In the case where the rental vehicle is checked out and rented by the hour, the network that manages and controls the rental vehicles could place a hold on the vehicle and not allow it to be rented or driven until a service check is performed to verify that the vehicle is safe to operate.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A potential chassis damage notification system for a vehicle comprising:
a sensor connected to the vehicle capable of providing data; and
a controller capable of receiving the data, comparing the data to a potential-damage range, and sending a potential-chassis-damage signal if the data is within the potential-damage range.

2. The system of claim 1 wherein the sensor is an accelerometer, and the data provided by the sensor is acceleration data.

3. The system of claim 1 wherein the sensor is connected to an unsprung component of the vehicle.

4. The system of claim 1 wherein the sensor is part of a supplemental restraint system that supplies the data to an internal communications network, and the controller accesses the data from the internal communications network.

5. The system of claim 1 wherein the sensor is part of an electronic stability control system that supplies the data to an internal communications network, and the controller accesses the data from the internal communications network.

6. The system of claim 1 wherein an indication of potential chassis damage is displayed on an instrument panel in response to the controller sending the potential-chassis-damage signal.

7. The system of claim 1 wherein the potential-chassis-damage signal is stored in a memory storage device and is saved along with a time stamp that may be accessed at a later time.

8. The system of claim 1 further comprising a transmitter in communication with the controller and the controller in combination with the transmitter transmits the potential-chassis-damage signal outside of the vehicle.

9. The system of claim 8 further comprising a remote receiver for receiving the potential-chassis-damage signal.

10. The system of claim 8 wherein the potential-chassis-damage signal is sent via a cellular network.

11. The system of claim 8 wherein the potential-chassis-damage signal is sent via a satellite network.

12. The system of claim 8 wherein the potential-chassis-damage signal is sent via a radio frequency transmission.

13. The system of claim 1 wherein the potential-damage range has a lower limit set at the data that would indicate normal operation of the vehicle and an upper limit set at the data that would indicate a collision event and set-off a supplemental restraint.

14. The system of claim 1 wherein a portion of the potential-damage range is lower than the data that would cause damage discernible by a driver while driving.

15. The system of claim 1 wherein a threshold value is set at an acceleration that an accelerometer would detect when the vehicle drives over a 7 inch straight-edge curb at 15 miles per hour.

16. A method of identifying potential chassis damage on a vehicle comprising:
receiving an acceleration data signal, comparing the acceleration data signal to a threshold value, and sending a potential-chassis-damage signal if the acceleration data is above the threshold value.

17. The method of claim 16 wherein the acceleration data signal includes an unsprung-mass-acceleration data detected by a first accelerometer connected to an unsprung component of the vehicle and a sprung-mass-acceleration data detected by an accelerometer connected to a sprung component of the vehicle, and the threshold value is a differential between the unsprung-mass-acceleration data and the sprung-mass-acceleration data.

18. The method of claim 16 wherein the potential-chassis-damage signal is provided to an internal communications network within the vehicle.

19. The method of claim 16 wherein the potential-chassis-damage signal is communicated to a driver of the vehicle.

20. The method of claim 16 wherein the potential-chassis-damage signal is transmitted outside of the vehicle to a remote receiver.
